(19) United States
(12) Patent Application Publication
(10) Pub. No.: US 2005/0066195 A1
(43) Pub. Date: Mar. 24, 2005

(54) Factor analysis of information risk

(76) Inventor: Jack A. Jones, Dublin, OH (US)

Correspondence Address: KREMBLAS, FOSTER, PHILLIPS & POLLICK, 7632 SLATE RIDGE BOULEVARD, REYNOLDSBURG, OH, 43068, US

(21) Appl. No.: 10/912,863

(22) Filed: Aug. 6, 2004

Related U.S. Application Data
(60) Provisional application No. 60/493,979, filed on Aug. 8, 2003.

(51) Int. Cl. H04L 9/00

(52) U.S. Cl. 713/201

(57) ABSTRACT

The invention is a method of measuring and representing security risk. The method comprises selecting at least one object within an environment and quantifying the strength of controls of at least one object within that environment. This is done by quantifying authentication controls, quantifying authorization controls, and then quantifying structural integrity. In the preferred method, the next step is setting global variables for the environment, for example, whether the environment is subject to regulatory laws, and then selecting at least one threat community, for example, professional hackers, and then calculating information risk. This calculation is accomplished by performing a statistical analysis using the strengths of controls of said at least one object, the characteristics of at least one threat community, and the global variables of the environment, to compute a value representing information risk. The method identifies the salient objects within a risk environment, defines their characteristics and how they interact with one another, utilizing a means of measuring the characteristics, and a statistically sound mathematical calculation to emulate these interactions and then derives probabilities. The method then represents the security risk, such as the risk to information security, such as by an integer, a distribution or some other means.

### (e) BACKGROUND OF THE INVENTION

1. Field of the Invention

This invention relates generally to information security, and relates more particularly to the measurement of various factors and the use of these factors in representing information risk.

2. Description of the Related Art

A conventional definition of risk is “exposure to loss.” Viewed another way, risk is the likelihood of a loss event, and the probable amount of loss associated with the event. This definition applies to all categories of risk, be it credit risk, investment risk, insurance risk, or information risk. Information risk, however, is a relative newcomer to the business risk landscape—at least as a significant concern.

Because information risk is relatively new as a business issue, the fact that it is fundamentally identical to the better-understood risk categories is not generally recognized. Unfortunately, this perception that information risk is somehow “different” or “less real” exists for many reasons, including the following.

First, the information risk management profession has not developed a common method for defining, measuring, and articulating risk. As a result, risk often is “measured” by analyzing control conditions alone, and without due consideration of threat frequency or capability, or the value of assets at risk. This approach leaves unanswered the questions of probability of loss events or probable loss magnitude, which is the basis for risk.

Second, the information risk landscape continually evolves as the reliance upon information and technology increases, threats change, new technologies are introduced, and new vulnerabilities identified.

Finally, most senior business leaders are used to dealing with risk issues that are supported by statistical data. Unfortunately, there is a lack of useful empirical data regarding information risk, which means that Annual Loss Expectancy and other standard statistical analyses are severely limited in their usefulness. This has left information security professionals largely to rely upon highly subjective and essentially unsubstantiated assessments of risk.

This last point is particularly problematic, as each of the more established risk sciences has an abundance of data that helps to define their risk landscapes and provide credibility. By comparison, solid data regarding information risk is hard to come by for three primary reasons:
1. Few organizations collect substantive data regarding information risk incidents.
2. No common taxonomy exists for describing and measuring information risk or the factors that contribute to risk, resulting in data that is inconsistent and difficult to correlate.
3. Those organizations that do collect incident and risk data aren't willing share it for fear that the information would result in embarrassment and reputational damage, or additional attacks.

Consequently, without a strong statistical underpinning, information risk analysis often is perceived as being based upon anecdotal data, opinions, and beliefs—rather than fact. Unfortunately, this perception is accurate given methodologies used to-date, which reduces the credibility of information risk analysis and its utility in making risk decisions.

In spite of these constraints, methods exist that claim to measure information risk. Unfortunately, none of these methodologies is based upon an understanding of the elemental factors that drive risk. As a result, these methodologies ignore key portions of the risk equation, focusing on technology controls and disregarding the role of people and processes, and/or they don't take into account the complex dependent and causal relationships between risk factors. Worse, many information risk methodologies assume that an absolute correlation exists between vulnerability and risk (failing to account for threat or impact variables), which results in inflated risk measurement, poorly informed risk decisions, excessive risk mitigation expenditures, and eroded professional credibility.

Therefore, the need exists for an information risk analysis method and framework that provides a taxonomy for risk elements, a set of measurement scales for the factors that drive risk, a mathematical model for emulating the relationships and interactions between risk factors, and a scenario modeling method. With such a framework, it becomes possible to describe and quantitatively measure information risk. Only through such a process can the full complexity of information technology environments be accounted for and a true measure of information risk be obtained.

### (f) BRIEF SUMMARY OF THE INVENTION

The purpose of information risk analysis is to enable the effective and efficient management of loss event probability and the probable loss associated with such events. Information risk occurs at the intersection of two probabilities—the probability that an action will occur that has the potential to inflict harm on an asset, and the probable loss associated with the harmful event.

In order to measure risk, the invention includes the consideration of both of these probabilities. Factor Analysis of Information Risk (FAIR—the invention) accomplishes this consideration of both probabilities specifically by providing a framework that includes:
A taxonomy for information risk that includes:
   A set of elemental components (objects) that make up the information risk landscape
   A set of variables that describe the characteristics of objects
   A decomposition of the factors that drive information risk and a description of the relationships between factors
A means of measuring risk factors and calculating risk using:
   A set of metrics with which to measure the risk factors
   A statistical model for determining the risk probabilities that result from the relationships and dependencies between various factors
A software program that provides an intuitive user interface for risk analysis

Key benefits of the FAIR invention include:
It provides a framework for understanding and modeling the elemental components of information risk
It provides a methodology for consistently and effectively measuring information risk
Factor measurement can take place at any level of abstraction within the model, which provides tremendous flexibility in its use
By understanding which factors within an environment have the greatest net affect, risk management decisions can become more effective and efficient (optimize Return on Investment: “ROI”)
The overall risk profile of an environment can be monitored as changes occur within portions of the risk landscape
By clearly articulating exposure and loss probabilities to executive management, and by understanding their expectations regarding what constitutes acceptable risk, an organization's risk tolerance can be defined. From that point forward, situations that drive the risk point outside of tolerance can be identified for mitigation
Because the FAIR process allows multiple risk conditions to be modeled, complex what-if analysis can be performed

FAIR identifies the salient objects within a risk environment, defines their characteristics and how they interact with one another, utilizes a means of measuring the characteristics, and utilizes a statistically sound mathematical calculation to emulate these interactions and then derives probabilities.

### (g) BRIEF DESCRIPTION OF THE SEVERAL VIEWS OF THE DRAWINGS

FIG. 1 is a chart depicting factors for risk

FIG. 2 is a chart depicting factors for exposure

FIG. 3 is a chart depicting factors for impact.

FIG. 4 is a chart depicting factors for threat event frequency.

FIG. 5 is a chart depicting factors for contact.

FIG. 6 is a chart depicting factors for action.

FIG. 7 is a chart depicting factors for vulnerability.

FIG. 8 is a chart depicting an expanded view of factoring.

FIG. 9 is a chart depicting a view of all factoring.

FIG. 10 is a chart depicting a conceptual illustration of imbedded objects.

FIG. 11 is a chart depicting a conceptual illustration of inherited exposure.

FIG. 12 is a group of graphs illustrating data used in a Monte Carlo analysis.

FIG. 13 is a graphic illustrating an example of a software program user interface.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose. For example, the word connected or term similar thereto are often used. They are not limited to direct connection, but include connection through other elements where such connection is recognized as being equivalent by those skilled in the art.

### (h) DETAILED DESCRIPTION OF THE INVENTION

The FAIR Framework. The FAIR framework describes the fundamental components and factors that comprise subject environments, as well as the relationships that drive the interactions between these components and factors. The manner in which these components and factors have been defined provides a framework that is highly flexible and entirely agnostic with regard to specific technologies or industries. A simple analogy to this framework is the atomic elements that make up our physical world. By defining and combining these atomic elements, one is able to describe and model complex molecules, which then can be further combined to describe and model higher-level subjects. If one can also understand the interactions of the elements at the various levels of abstraction, one is able to model not only the structure of complex subjects, but also their capabilities and tendencies. Through this modeling, one can make reasoned predictions of how certain combinations of elements will act.

The FAIR Program. The instant invention (FAIR) allows users to emulate information risk environments on virtually any scale, from extremely simple to highly complex. This is possible by using elemental components to model an environment. This can be accomplished manually or, in the preferred embodiment, by using a software program having a graphical interface. The program discussed below provides a drag-and-drop capability with which the user can “build” on screen a virtual representation of the environment under analysis.

The objects selected by the user have variables associated with them that represent the characteristics of the objects. The values assigned to those variables describe the object and its behavior and the manner in which it interacts with other objects.

Variable values can be set by the user, imported from formatted text files, or imported from 3^{rd} party compatible programs such as asset management systems. An appropriate mix of the above methods can also be used depending upon the needs and capabilities of the user. Also, the program comes with many of the variables assigned default values, which can be changed by the user as appropriate.

There also are global variables that define characteristics of the overall environment and define the context for the risk analysis. The user can set these values as appropriate.

The program uses the selected objects, the object characteristics as defined by variable values, and the global environmental characteristics to mathematically compute the probability of loss events and probable loss magnitudes. The program also helps the user identify other characteristics of the risk environment, such as:
Key points of vulnerability (weak links)
Potential single points of failure (fragility)
Points of instability
Highest points of risk, impact, exposure, vulnerability
Most significant threat
Likely opportunities for applying control at points of leverage
Average level of risk per object
Lowest points of risk

The FAIR Program Components. There are three primary component categories in the invention—objects, threats, and controls. Various subcategories exist for each of these categories, as described below.

“Objects” are the physical, logical, and virtual building blocks that make up the environment whose risk is being measured and represented. Examples of objects include, but are not limited to:
Buildings
Offices
Networking systems
Network transmission media
Storage media
Servers
Applications
Databases
Data
Workstations
Firewalls
Humans
Processes

Objects are defined by a set of characteristics that are common to virtually all objects (threat agent objects have a different set of characteristics, described below). These characteristics enable the user to describe the manner in which objects interact with other objects and threat agents within the information risk environment. Examples of object characteristics include, but are not limited to:
Value
   Intrinsic
      Sensitivity
      Expected loss per day
      Market value
   Inherited
      Sensitivity
      Expected loss per day
      Market value
Control effectiveness
   Preventive
      Authentication
      Authorization
   Detective
      Logging
      Reporting
   Response
      Containment
      Reaction
      Expected recovery time
Descriptive
   Type (subtype)
      Technology (data, system, media, application, etc.)
      Process (design, implementation, maintenance, use, etc.)
      Human (executive, technologist, etc.)
      Physical structure (building, system [power, commercial, etc.])
      Class (subclass)
         Ideology
         Religious (Christian, Muslim, etc.)
         Political (Democracy, Communist, etc.)
         Country (U.S., U.K., etc.)
         Industry (Finance, insurance, government, etc.)
         Company Name

Note that additional characteristics can be defined, thereby extending the specificity and power of the object set.

“Threat Agents” are specialized types of objects that have the ability and/or tendency to inflict harm upon objects. Threat Agents fall into one of four high level categories:
Humans
Animals
Environmental elements (e.g., wind, temperature, liquid, gravity, etc.)
Human-made objects

“Threat Communities” provide a means of describing a set of threat agents that share common characteristics. Examples of threat communities include, but are not limited to:
Human
Human
   Activists
   Terrorists
   Organized crime
   Disgruntled employees
   Ex-employees
   Employees
   Customers
   Professional hackers
   Non-professional hackers
   Corporate spies
   Nation-state intelligence services
Animals
   Vermin
   Parasites
Environmental
   Weather (tornados, floods, etc.)
   Geographical disturbances (earthquakes, volcanic eruptions, etc.)
Man-made objects
   Computer viruses and worms
   Trojan horse programs
   Explosives
   Corrosives
   Vehicles
   River dams

A person of ordinary skill will understand that the list above represents only a sample. The variety of threat communities and sub-communities that can be defined is virtually unlimited.

Threat communities are defined by a set of characteristics that describe capabilities and tendencies. These characteristics establish the frequency and manner in which threat agents interact with objects within the information risk environment. Threat community characteristics include, but are not limited to:
Volume
Level of activity
Capability (force)
   Skill
      Knowledge
      Experience
   Resources
      Time
      Materials
Risk tolerance
Selectiveness
Primary motive (Politics, religion, financial gain, revenge, ego gratification, etc.)
Secondary motive (Politics, religion, financial gain, revenge, ego gratification, etc.)
Primary intent (access/use, destroy, steal, modify, disclose, deny use, etc.)
Secondary intent (access/use, destroy, steal, modify, disclose, deny use, etc.)
Privilege level
Contact mode
   Random
   Targeted
Approach tendencies
   Direct/indirect
   Force/guile
Vector tendencies
   Technology
   Human
   Physical

Note that many of the characteristics described above apply more to cognitive threat agents such as humans, than they do to the other threat categories. This stems from the fact that humans represent a vastly more complex subject, which requires a greater variety of characteristics to effectively describe. When characterizing a threat such as a tornado, most of these human-specific characteristics would be left blank or set to a default value.

Using a threat community construct allows us to define and model capabilities and tendencies for threat agents. This resolves the problem of trying to characterize the tendencies of an individual threat agent when a specific individual agent is unknown. This approach is similar to the method used by criminologists to model the tendencies of classifications of criminals when it is otherwise impossible to know in advance the tendencies of any individual criminal.

“Controls” are not a separate type of object but rather a characteristic of objects. Three types of controls are defined within FAIR: preventative, detective, and responsive. “Preventive controls” are intended to prohibit or constrain threat agents from harming objects. “Detective controls” are intended to identify and report when a threat agent is in the process of, or has succeeded in, overcoming preventative controls. “Responsive controls” are intended to limit the amount of loss associated with an event.

There are typically only three types of preventive controls: authentication, authorization, and structural integrity. Authentication is the step of validating who a subject is. This validation can be based upon one or more factors, and the validation can be performed manually (i.e., by one or more humans who have the responsibility for authenticating subjects) or programmatically by mechanisms designed to perform this function. Authorization is the process by which a subject who has been authenticated is granted privileges to perform specific actions. Note that authorization is predicated upon authentication.

Instances may exist where authentication is performed, but no granularity (i.e., separate limit) exists in authorization controls. For example, if an authorization control exists to validate entry to a room, there may subsequently be no effective (or desired) means of constraining what takes place within the room. In this case, then, authorization control is limited to allowing or denying the privilege to enter the room.

It is important to note that some objects may not have any intrinsic authentication or authorization capabilities. For example, a paper lying on a desk is an object that, by itself, is incapable of performing any form of authentication or authorization. Consequently, this object is accessible by any threat agent that has already satisfied (or bypassed) the controls provided by the environment in which the paper resides (e.g., guards within an office space). Objects like this paper are characterized as having no effective authentication or authorization controls.

Structural controls serve two purposes.

First, they prevent threat agents from directly affecting an object. For example, the strength of the foundation, framing, walls, etc., that form the structure of a building, determine its ability to withstand the force applied by high winds, water, explosions or other physical threats.

Second, they prevent a threat agent from circumventing authentication and authorization controls. For example, physical characteristics such as wall thickness and density play a role in determining its ability to resist penetration by a threat agent who chooses not to face authentication and authorization controls at the normal point of entry to the object.

Detective and Responsive Controls. The effectiveness of an object's detection and response controls determine the length of time a threat agent has to gain access or inflict harm. These controls also play a key role in establishing the defense-in-depth characteristics of a multi-level object environment.

Detective control mechanisms and processes have two primary purposes: To identify when a threat event takes place, and to initiate the object's responsive controls.

Responsive controls mechanisms and processes have three primary purposes: To contain the effect a threat agent is having on an object, to investigate and remediate (if possible) the source of the threat, and to recover the information or systems affected by the event.

A rapid detection and response capability can help prevent threat agents from successfully affecting an object (or at least limiting the degree of affect). Therefore, it is possible for these controls to serve a preventative purpose. This capability is somewhat dependent, however, on the length of time it takes a threat agent to affect an object.

Detection and response controls play a substantial role in the defense-in-depth characteristics of a multi-level environment. For example, if the perimeter of a network object is breached, effective detection and response capabilities provide the means of preventing further compromise of objects within the network.

Factor Decomposition. The interaction of objects and threats within an environment drives the probable frequency and magnitude of loss. These probabilities are, in turn, driven by numerous factors that may be discrete and measurable, or that may be derived from other, even more granular (discrete and measurable) factors. The first step, then, is to identify these factors. Note that any complex subject in the real world is too complex to model exactly. Nonetheless, by identifying key factors and their interactions, an effective approximation of an environment can be developed. The factoring within FAIR provides this taxonomy of key factors within and between risk components.

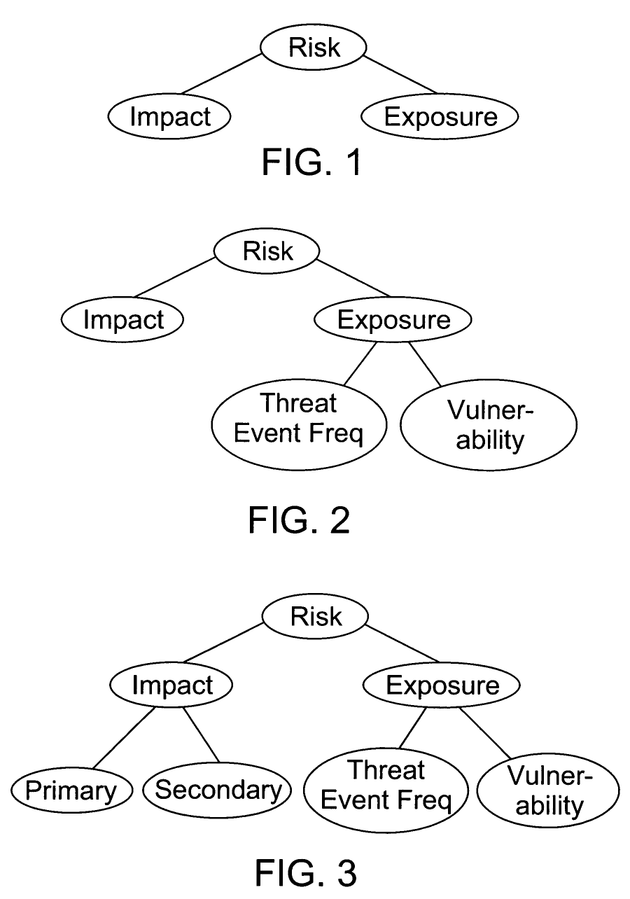

Factoring Risk. FAIR defines information risk as occurring at the intersection of two primary probabilities (FIG. 1):
1. The probability of a loss event (exposure)
2. The probable loss magnitude (impact)

Factoring Exposure. The probability of a loss event is dependent upon two primary contributing factors (FIG. 2):
1. The probability of a threat agent acting against an asset (threat event frequency)
2. The probability that the asset is vulnerable to the action taken against it (vulnerability)

Factoring Impact. The probability of loss magnitude is driven by two categories of factors (FIG. 3):
1. Primary factors, which are common to all types of loss
2. Secondary factors, which are unique to the various types of loss (loss domains) described below:
   Legal—Losses due to legal costs, fees, fines, etc.
   Regulatory—Losses due to regulatory actions
   Competitive Advantage—Losses due to reduced competitive advantage
   Operational—Losses due to operational degradation
   Reputational—Losses due to reputational or brand damage

Factoring Threat Event Frequency. The probability of a threat agent acting against an object is driven by two primary factors (FIG. 4):
1. The probability that a threat agent will come into contact with an object
2. The probability that a threat agent, once contact has occurred, will take action against the object

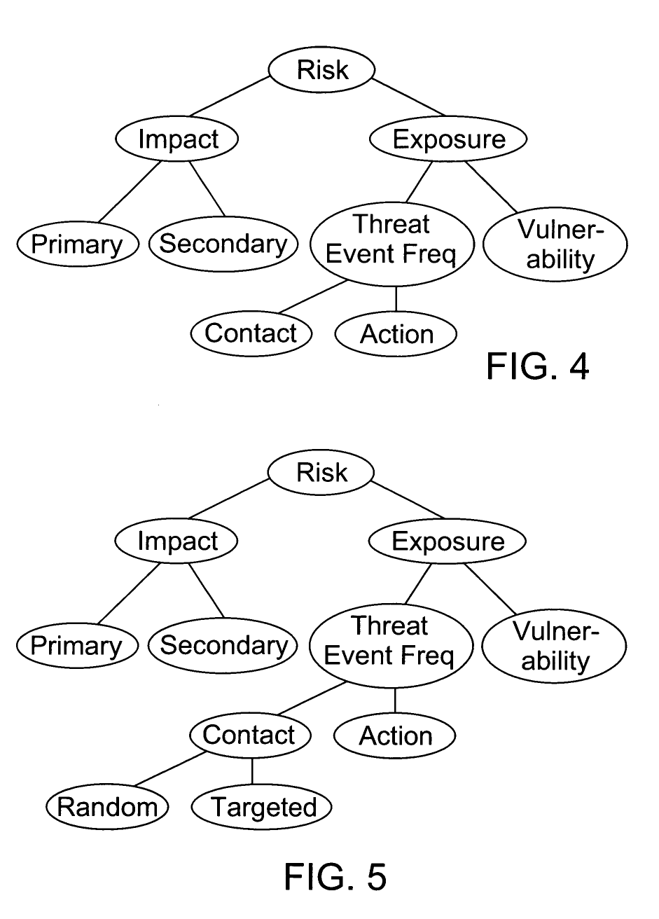

Factoring Contact. Two types of contact can occur between a threat agent and an object (FIG. 5):
1. Random
2. Targeted

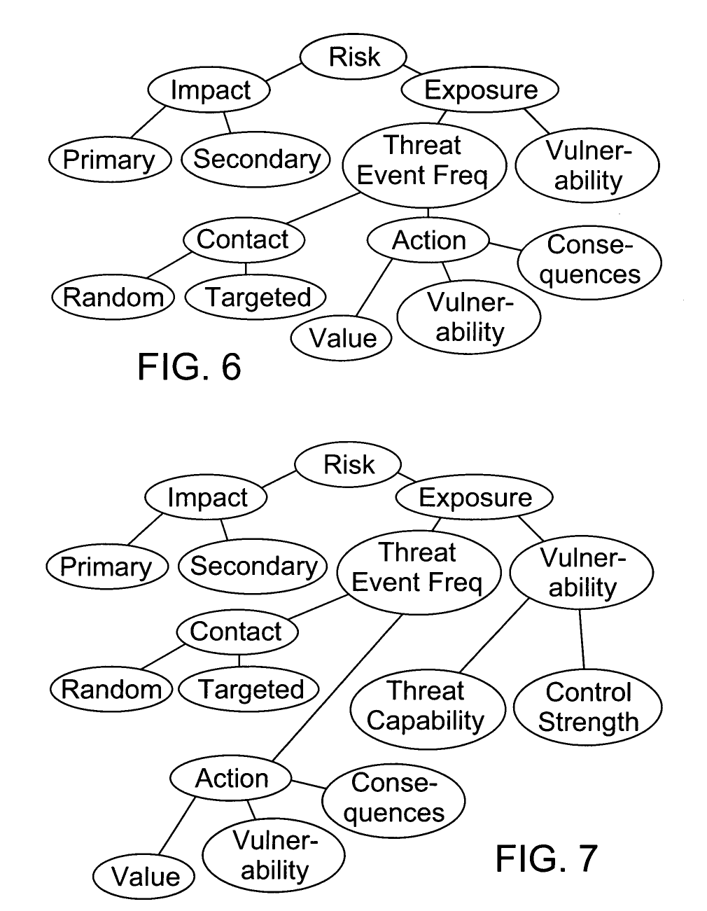

Factoring Action. The probability of action on the part of a threat agent is driven by (FIG. 6):
1. Value of the object relative to the threat agent's motives and intent
2. Vulnerability of the object relative to the threat agent's capabilities
3. The probability of unacceptable consequences to the threat agent (e.g., being caught and punished)

Note that these factors only come into play for cognitive threat agents. Threat agents that don't exercise choice in taking action (e.g., tornadoes, etc.) always act against the objects they encounter.

Factoring Vulnerability. The probability of object vulnerability is driven by (FIG. 7):
1. Threat agent capability
2. Strength of controls within an object

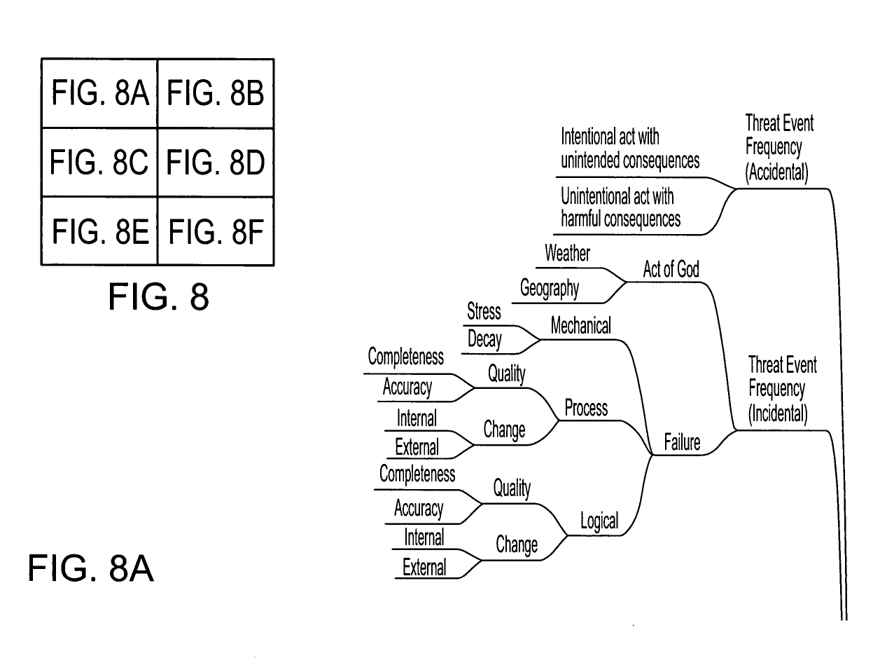

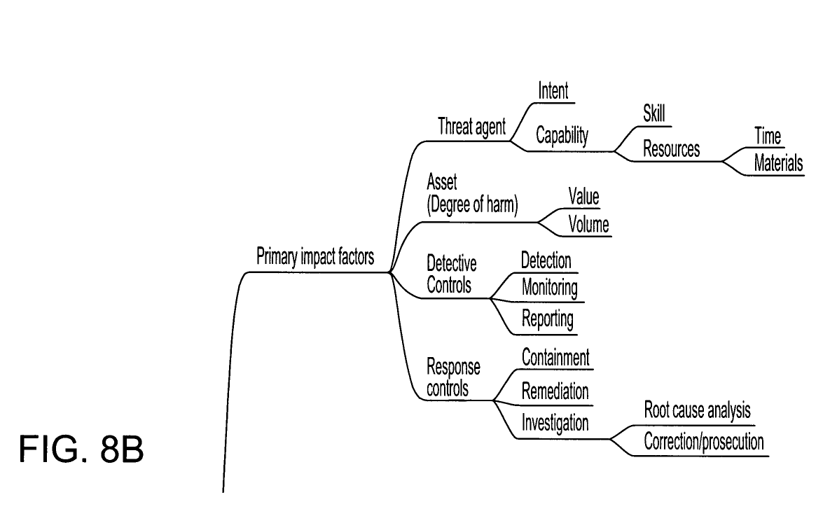

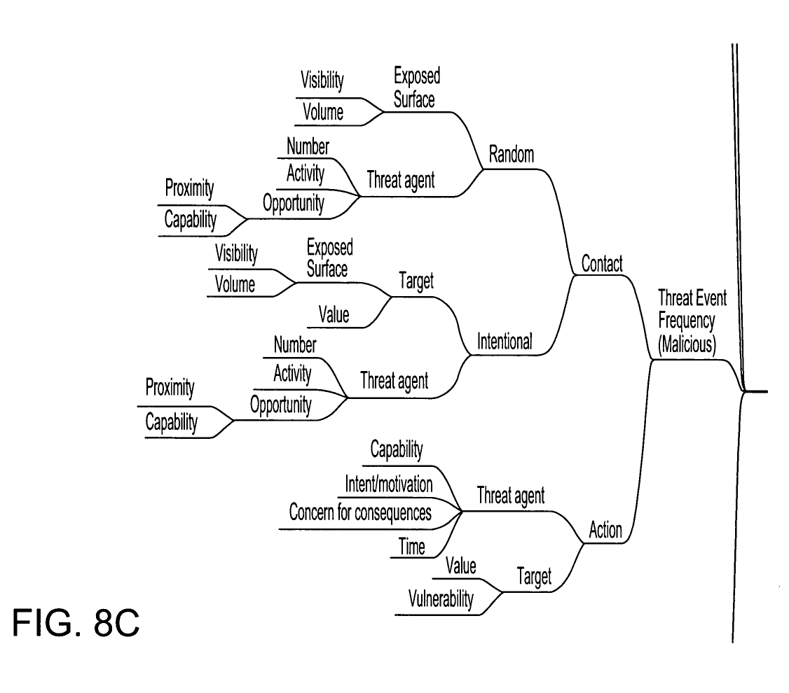

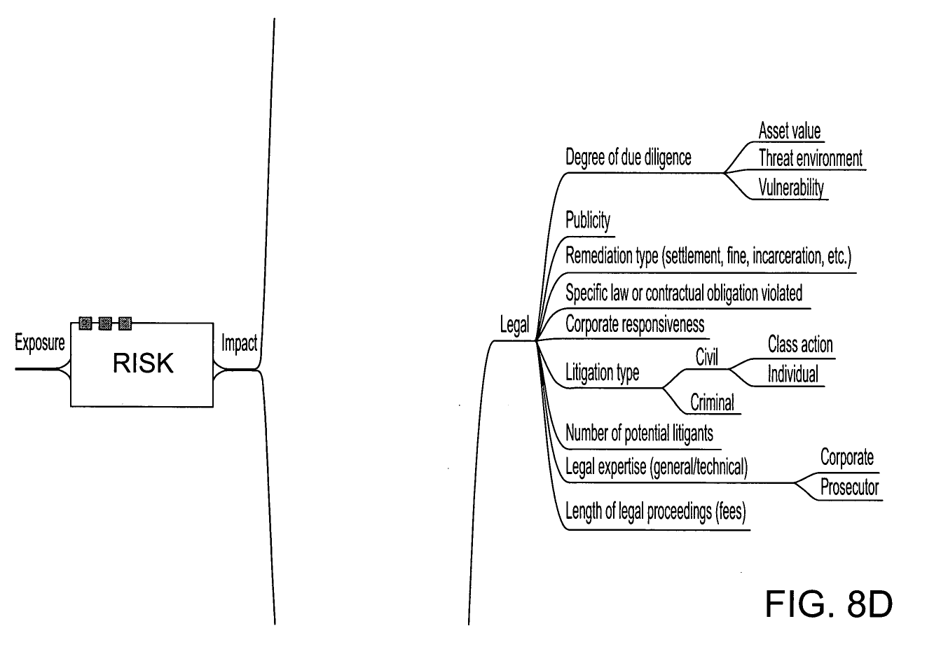

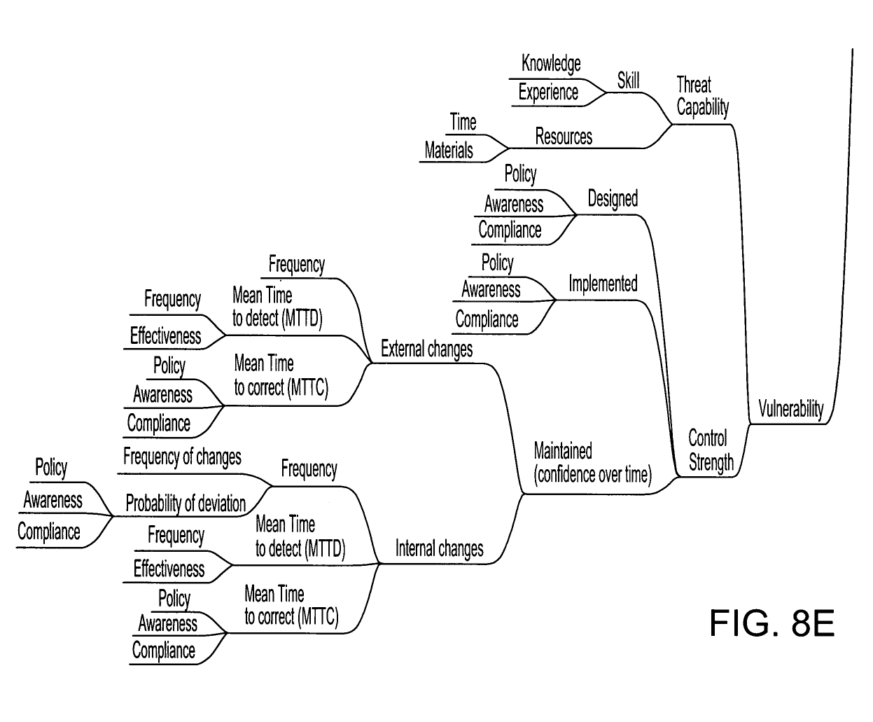

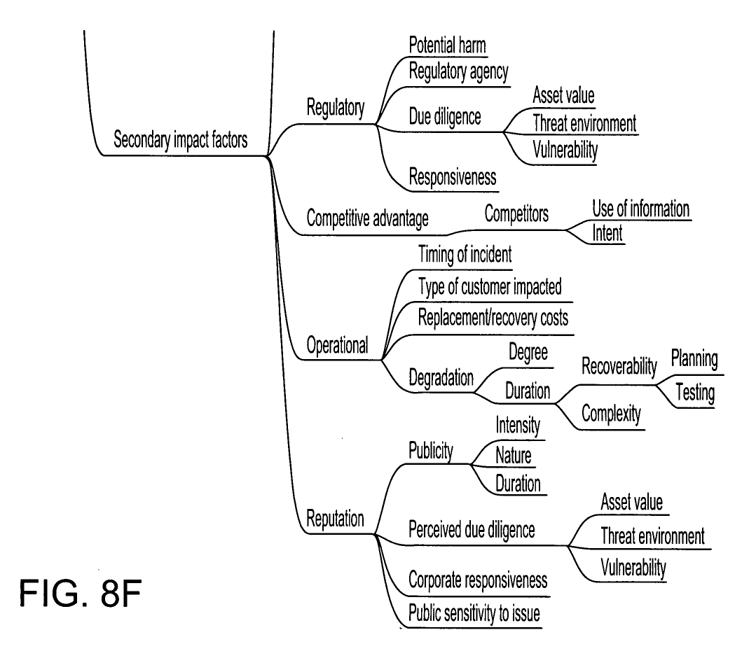

An additional layer of factoring exists within the current version of the FAIR program. It is at this next level that the user of the model applies measurements (FIG. 8).

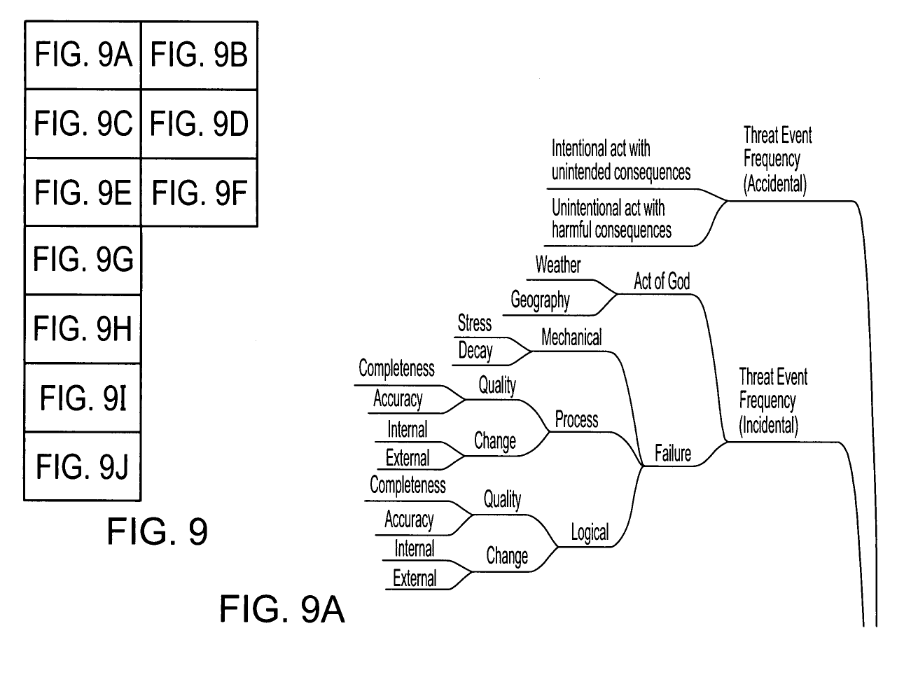

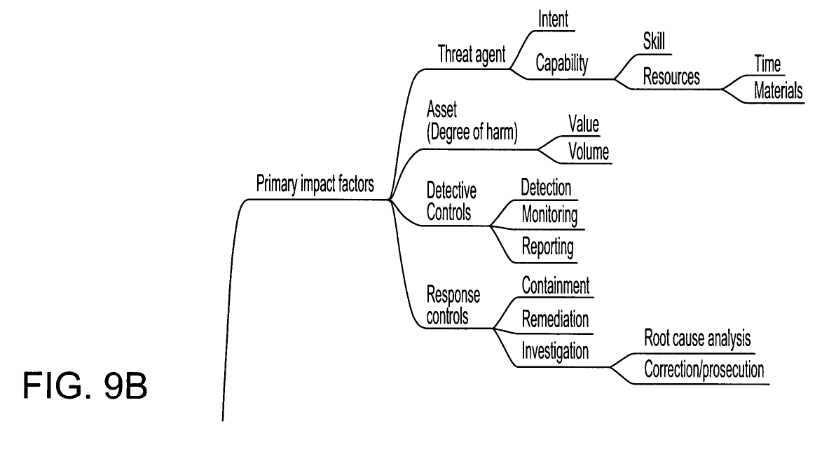

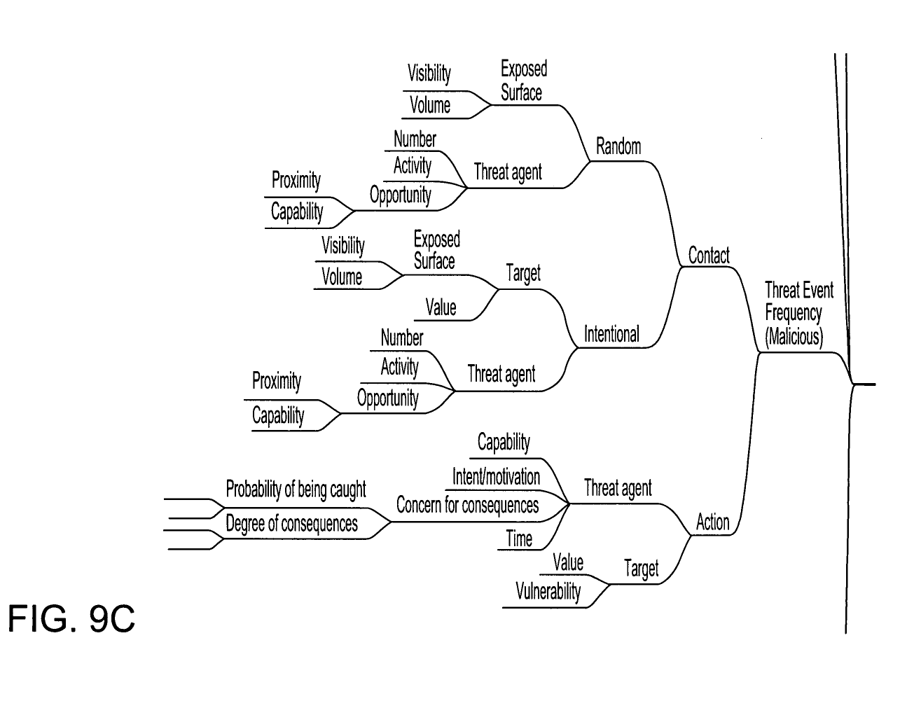

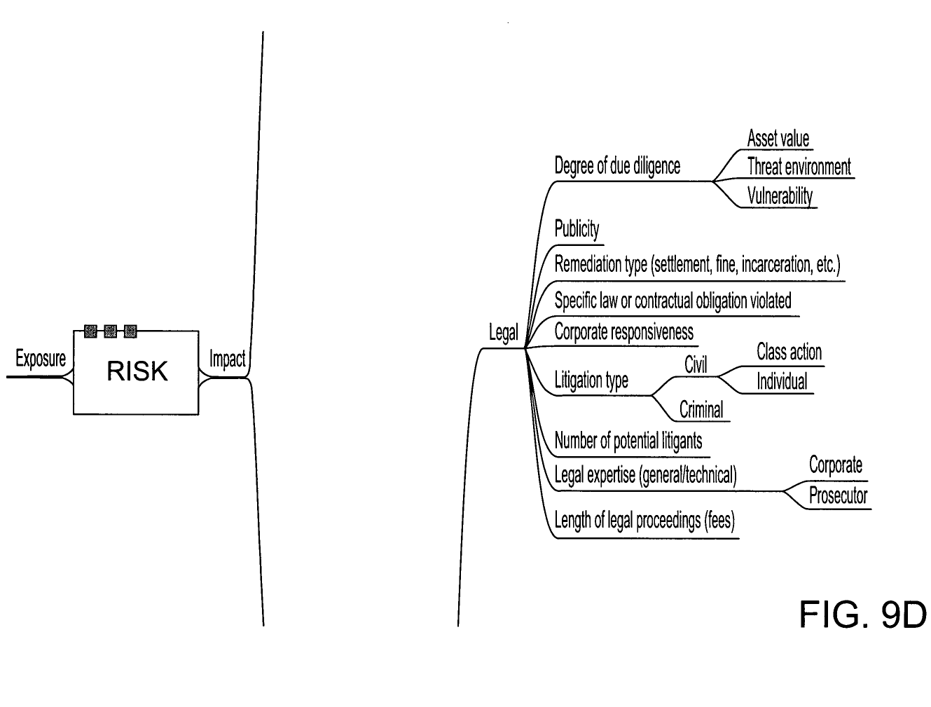

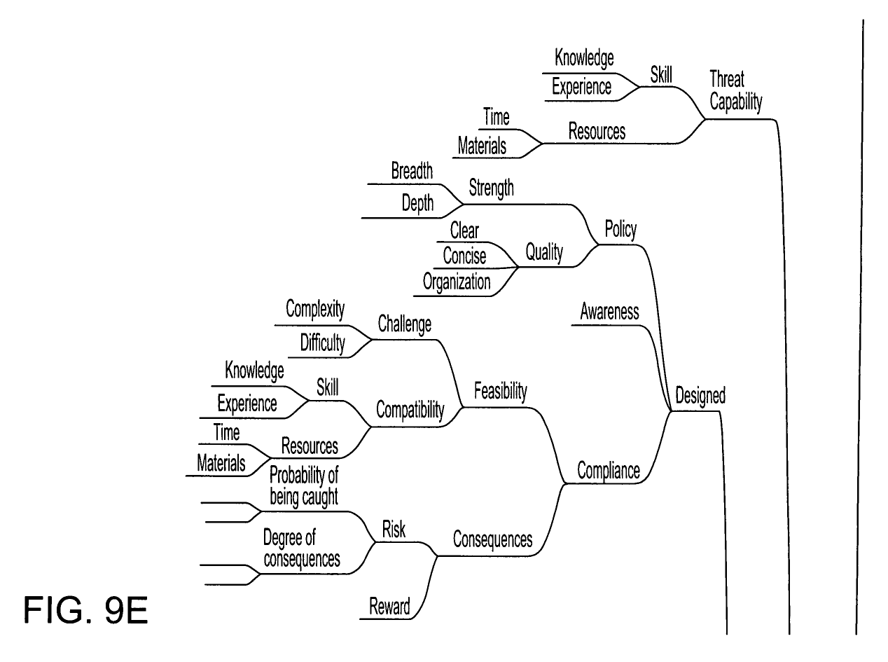

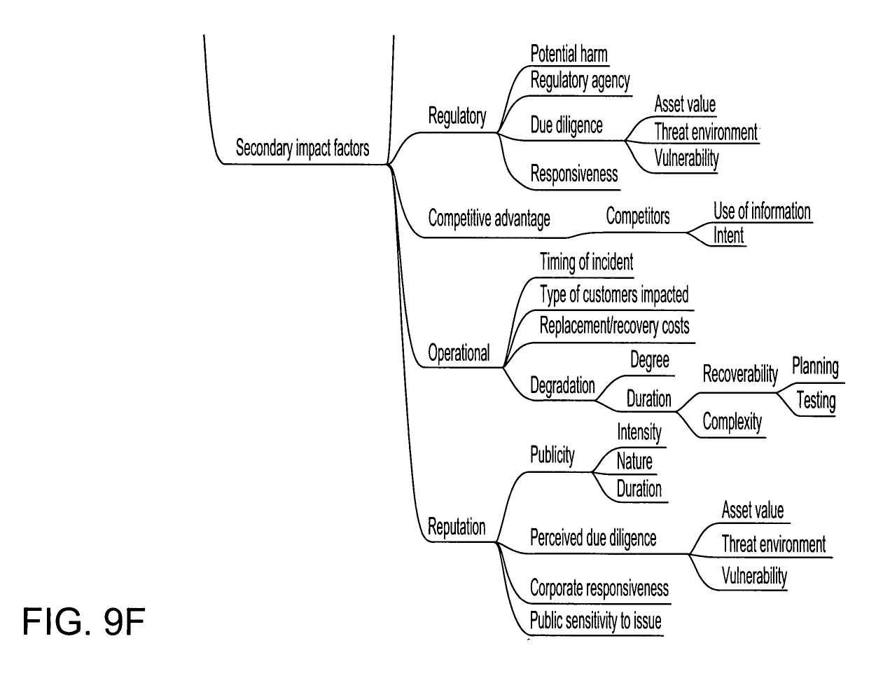

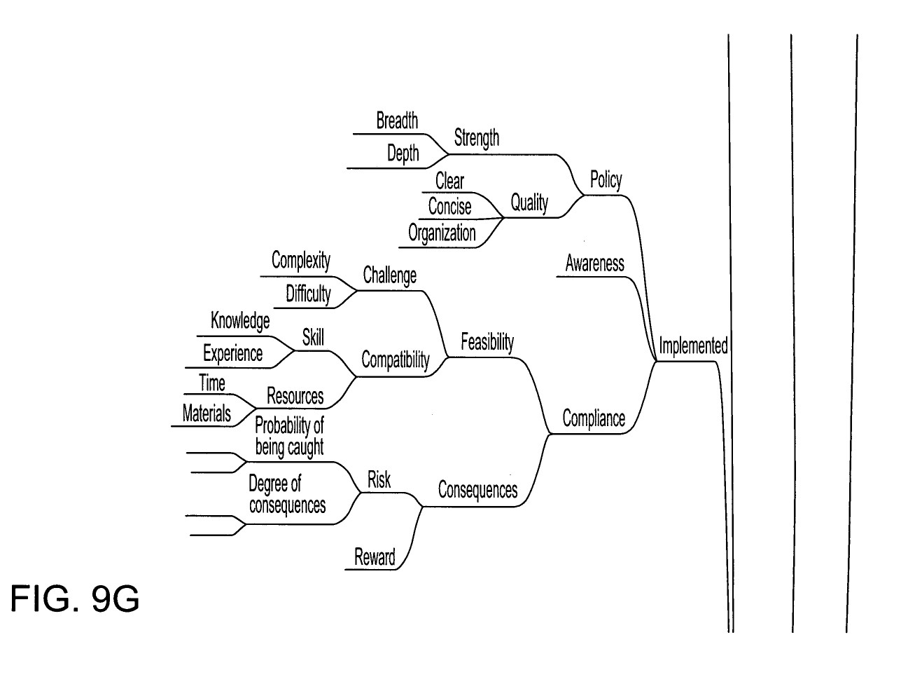

Note that this factoring process has been extended beyond the point of actual use within the application (FIG. 9). The benefits from this include the potential to extend the depth of FAIR application analysis, as well as a clearer understanding of risk.

FAIR employs a concept referred to as “object modeling” to enable the simulation of complex risk environments. The object model construct defines the rules that describe the relationships between objects, and between objects and threat communities.

Basic Building Blocks. The basic building block of the object model is the object, which is described above. Every object has a set of characteristics that describe the object and how it interacts with other objects and threats within its environment. Most of these characteristics are intrinsic to the object, but some characteristics can be inherited based upon the object's relationship to other objects.

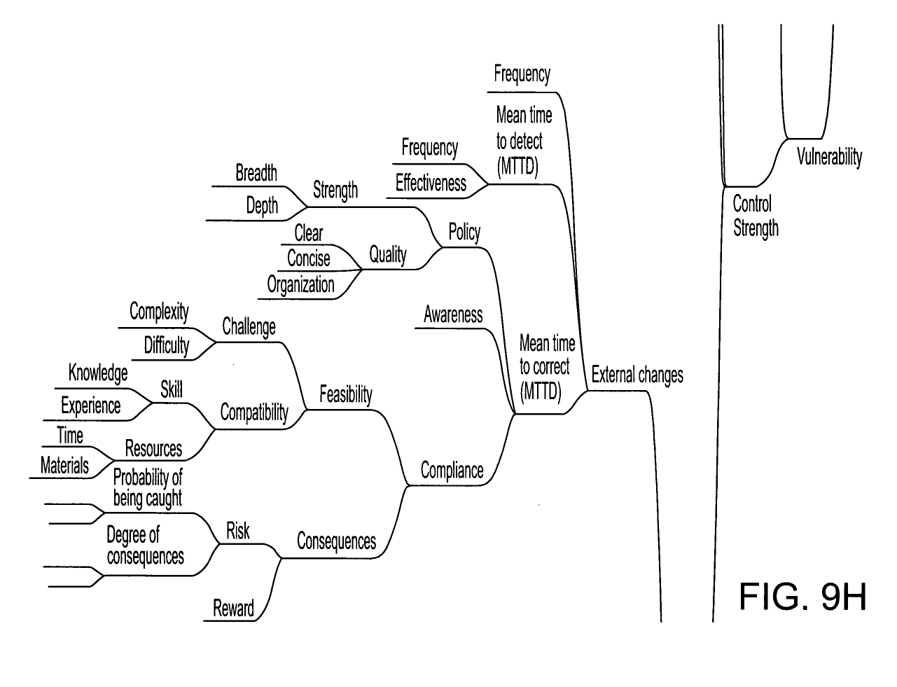

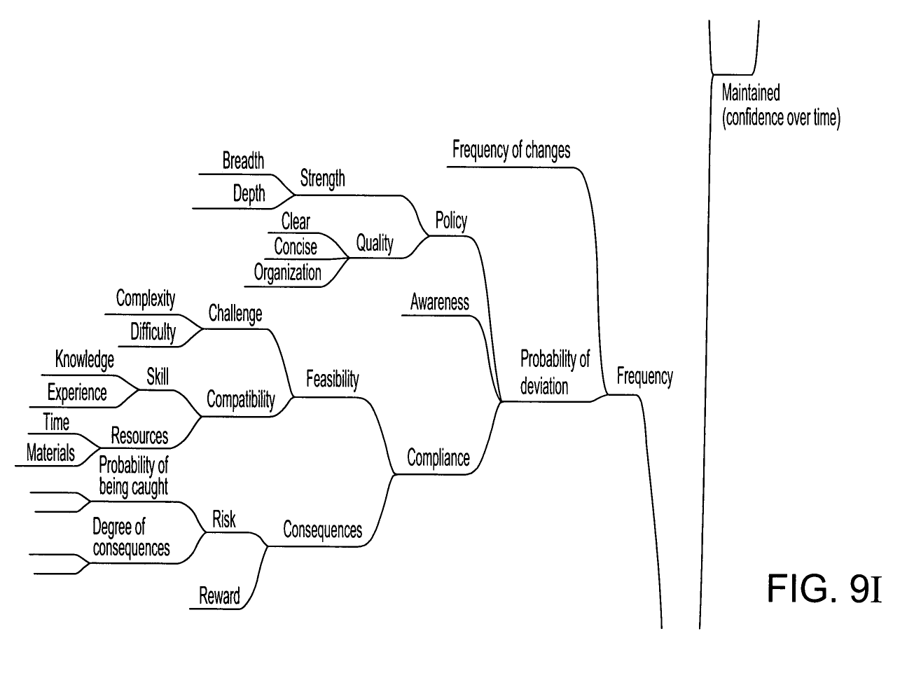

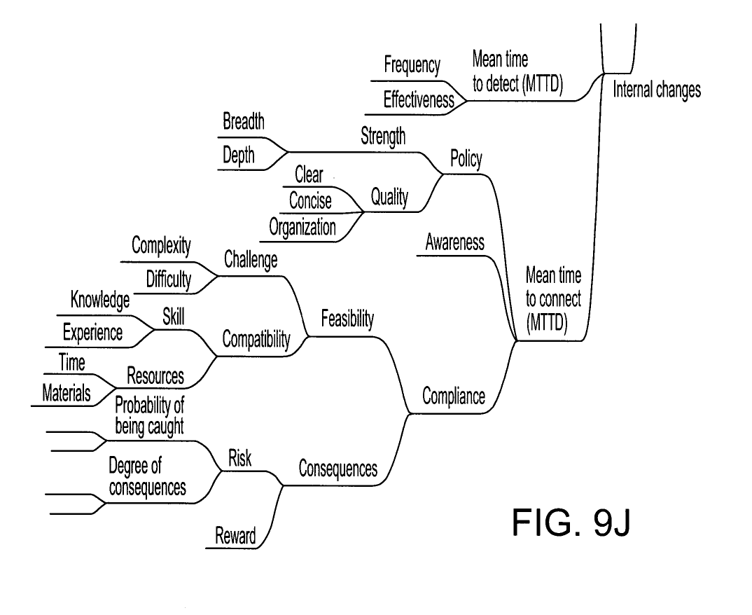

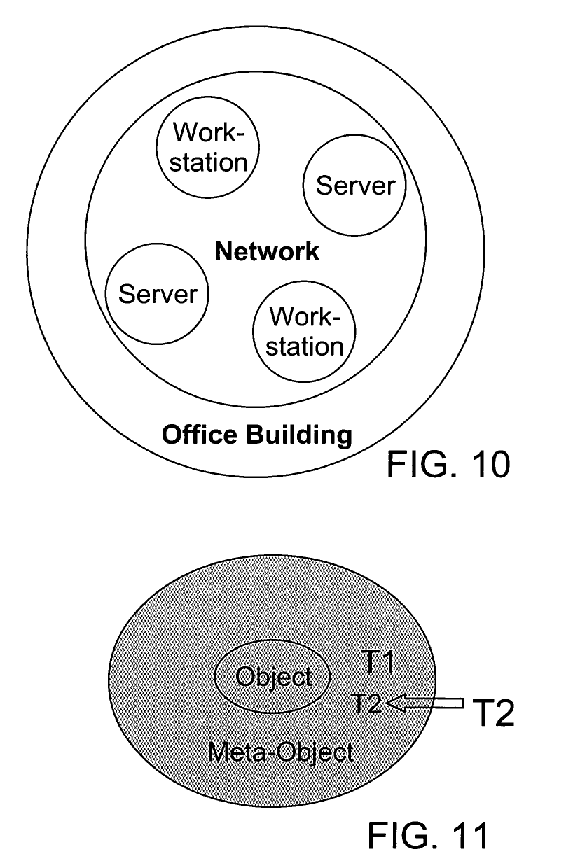

Within the object model, an object that contains another object is called a meta-object. An office building would be one example of a meta-object, and the offices, networks, and systems within the building would be the objects contained within the meta-object. Within this same example, the network within the building also would be a meta-object, as it would “contain” the servers and workstations connected to it (FIG. 10). This ability to contain objects within other objects enables the simulation of extremely complex environments.

Inheritance. All objects have intrinsic value based upon a number of factors—e.g., purchase or acquisition cost, market value, strategic value, sensitivity, operational criticality, etc. This value is what drives financial loss when an object is lost, damaged, stolen, or illicitly disclosed. Within FAIR's object model, objects also can have inherited value. For example, a computer server can contain a database, which contains data. In this scenario, the server meta-object contains a database meta-object, which contains data. Each of these objects has some level of intrinsic value, however, the meta-objects also inherit the value of the objects they contain.

The other inherited characteristic within the object model is exposure. Within FAIR, exposure represents the probability of a loss event. Therefore, recognizing that all objects exist within environments that have one or more intrinsic threat categories or threat communities, an object contained within a meta-object inherits some degree of exposure based upon the threat and strength characteristics of the meta-object. For example, a document residing within an office environment faces an intrinsic threat community made up of the people who legitimately work within the office. In this case, the document object is the primary object, and the office is the meta-object. The controls employed by the office environment to prevent illicit access to its contents by external threats (such as professional criminals), combined with the level of external threat the office environment faces (the probability of attack), determines the probability that a contained object like the document would face an external threat community (FIG. 11).

FAIR's object model enables the user to represent effectively the fact that objects face not only their intrinsic threat communities, but also some degree of external threat based upon the control characteristics of the meta-object and the level of external threat. This feature enables FAIR to reflect defense-in-depth (or the lack thereof) within an environment.

Effectively determining the probability of any future event is difficult. The most common formal means of predicting the likelihood of future events relies on large bodies of empirical data gathered over time. Although generally recognized as an acceptable approach, this data-driven method relies upon several key assumptions:
1. That the data is accurate
2. That the data effectively represents the spectrum of possibilities, and that there aren't data missing that would materially change the probabilities
3. That the circumstances and environmental conditions that generated the data haven't or won't undergo a material change in the future that would invalidate the predicted probabilities

Because risk exists at the intersection of two probabilities—the probability of a loss event (exposure), and the probable magnitude of resulting loss (impact)—risk is doubly difficult to determine or measure. Furthering the challenge in the information risk realm are several facts:
1. There is no statistically significant body of data available regarding information risk
2. The data that do exist have no basis for correlation due to the absence of a standard taxonomy against which to normalize
3. The specific technologies, architectures, and threat conditions within the information risk landscape evolve rapidly, resulting in serious limitations in the utility of past data for projecting future probabilities

Even assuming that the first two of these issues are resolved, the third issue is likely to continue to limit the potential for meaningful data-driven statistical analysis of information risk for the foreseeable future.

The other means of predicting the likelihood of future events is through a thorough understanding of the components within an environment and how they interact. This is the method that the present invention (FAIR) employs. FAIR identifies the salient objects within a risk environment, defines their characteristics and how they interact with one another, establishes a means of measuring the characteristics, and establishes a statistically sound mathematical approach to emulating these interactions and deriving probabilities.

General Measurement Approach. Measurements are intended to establish and convey the nature of some attribute, typically in order to support better understanding of the attribute, for making comparisons, or as an aid in decision-making. In order for probability measures to be credible, it is critical that the key factors from which risk is derived are included in the analysis, and that a strong correlation exist between the measurement scales and the attributes being measured.

FAIR allows the analyst to measure factors by three methods:
1. As discrete values,
2. As ranges, or
3. As distributions across a scale that represents a ratio

When distributions are used, the maximum, minimum, and mean values for the distribution are selected, and a set of distribution shapes (e.g., standard bell curves, triangle, skew left or right, etc.) is formed. The advantage to using distributions is that they provide tremendous flexibility in describing the attribute, and they more readily enable determining joint probabilities using conventional statistical analysis, such as the Monte Carlo analysis. The following paragraphs provides a top-down description of the manner in which risk is decomposed into its component factors in the preferred embodiment of the invention, as well as the manner in which the relationships between those factors are modeled.

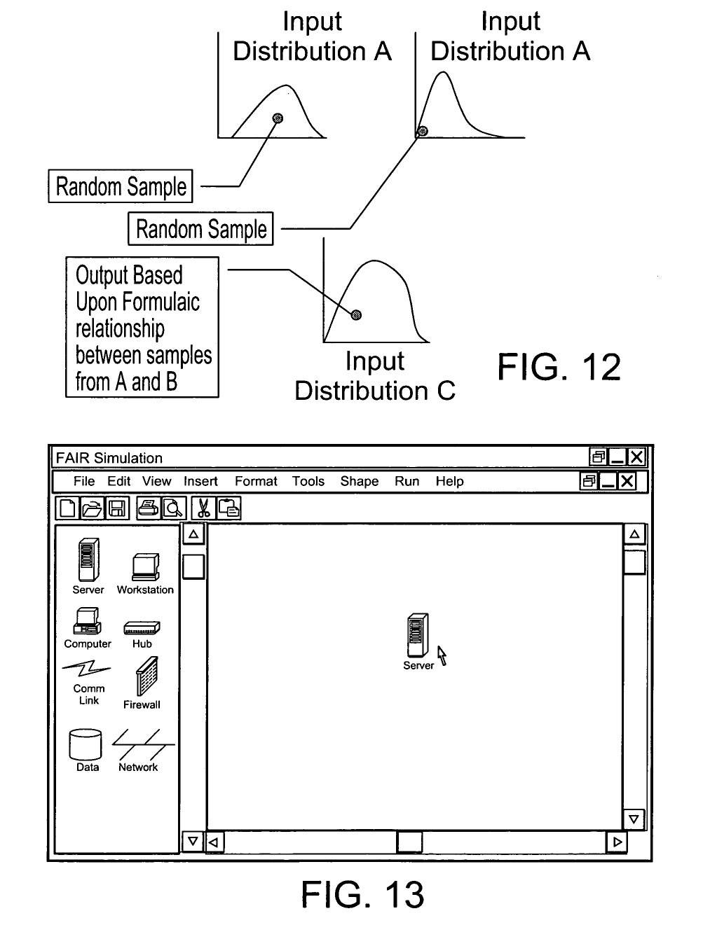

Deriving Risk. Risk is derived using Monte Carlo (MC) analysis of two probability distributions—the probability of a loss event (exposure), and the probable loss magnitude (impact). This is accomplished by taking a random sample value from both the Exposure distribution and Impact distributions, multiplying the values, and plotting the result on a X-Y graph (FIG. 12).

The number of random samples (i.e., the number of Monte Carlo cycles) is configurable by the user. It will be recognized that more iterations provides better statistical accuracy, but at the expense of program speed.

Deriving Exposure. In order for a loss event to occur, a threat agent (e.g., tornado, flood, hacker, etc.) has to act against an object. Furthermore, the object must be vulnerable to the threat in order for loss to occur. Consequently, it can be said that exposure exists at the intersection of two probabilities: the probability of an act against an object, and the probability that the object will be vulnerable to the act (FIG. 2). For example, a computer's probability of experiencing a loss event (its exposure) from a hacker attack is dependent upon the probability of a hacker acting against the computer (threat event frequency), combined with the probability of the computer being vulnerable to the hacker's efforts (vulnerability).

Just as risk is computed by combining exposure and impact through MC analysis, exposure is derived by MC analysis of Threat Event Frequency and Vulnerability distributions. Each MC cycle samples these distributions and multiplies the samples, creating an output distribution, which represents exposure (FIG. 12).

Deriving Threat Event Frequency. In order for loss to occur, a threat event has to occur that can generate loss. These events can be intentional (attacks), accidental (e.g., fire), or incidental (e.g., tornado). The probability of a threat event occurring is driven by two factors: the probability of a threat agent encountering an object, and the probability that the threat agent will act against the object once contact is made (FIG. 4).

MC analysis is performed here, too, with random samples drawn from the Contact and Action distributions. Here again, with each MC cycle, the Contact and Action samples are multiplied to construct an output distribution, which is Threat Event Frequency (FIG. 12).

Deriving Contact. The frequency with which a threat agent encounters an object is derived from two different types of contact—random and targeted (intentional) (FIG. 5). The degree to which random and targeted contact occurs is determined by a combination of threat, object, and environmental characteristics.

Deriving Random Contact. The threat community characteristics that drive random contact include the number of threat agents within the threat community (volume), the level of activity exhibited by the threat community, and the degree to which the threat community engages in random target acquisition (selectivity), versus the amount of their efforts that go toward establishing targeted contacts.

The “surface area” of the object is the other component of the random contact function. This value is determined by dividing 1 (the object) by the number of objects within the environment. For example, if the object in question resides within an environment containing 99 other objects, the relative surface area for the object is 0.01.

The formula for deriving random contact is:
threat volume×threat activity×threat selectivity×object surface area

Deriving Targeted Contact. The factors that contribute to targeted contact frequency include threat community volume, activity, and selectivity factors, as well as the surface area of the object, just as in random contact derivation. The difference between the random contact function and the targeted contact function results from to changes: 1) an inversion of the selectivity value, and 2) the addition of descriptor matching. Descriptor matching entails comparing characteristics between the threat community and the object to determine whether the object matches the target preferences of the threat community. For example, if the object has a market value of $100,000 and the threat community target market value criteria was $10,000, the strength of the match would be 10 (object value divided by threat community target value criteria).

The formula for deriving targeted contact is:
threat volume×threat activity×threat selectivity×object surface area×match strength

Deriving Probability of Action. Once contact takes place, the decision of whether or not to act against an object depends upon three factors, including the value of the object, the vulnerability of the object, and the level of risk to the threat agent of negative consequences (FIG. 6). Note that each of these values is considered from the perspective of the threat agent. In other words, how valuable the target is in the eyes of the threat agent, how vulnerable it appears to be (the likelihood of a successful breach), and how likely it is that the threat agent would be detected, caught, and suffer unacceptable consequences. These considerations are driven by the characteristics of the threat community (e.g., motive, intent, capability, risk tolerance, etc.). For example, threat agents within the terrorist threat community are more likely to act against highly critical, highly visible targets associated with particular countries or ideologies. A simplified matching illustration follows:

| | |
|---|---|
| Threat Community | Object |

| | |
|---|---|
| Preferred targets by value | Values |

| | |
|---|---|
| Criticality: $100,000 | Criticality: |
| $10,000 | |
| Sensitivity: 4 | Sensitivity: 4 |

| | |
|---|---|
| Preferred targets by type | Type descriptors |

| | |
|---|---|
| Religion: Muslim | Religion: |
| Christian | |
| Country: USA | Country: USA |

Using these characteristics to determine matching, we see that matches occur on the Sensitivity and Country variables, but not on criticality or religion. Whether or not these matches are sufficient to contribute to action depends upon the intent of the threat community. If this threat community were seeking sensitive information (e.g., if the threat community were a government intelligence agency or corporate espionage group), then the match would be positive. If, however, the threat community were a terrorist organization, whose intent is to inflict maximum destructive damage, the match would be negative.

Note that FAIR also can be used to assess the risk associated with potential incidental or accidental threat events (e.g., tornado, fire, etc.). In these cases, because the threat agent makes no decision about whether an action takes place or not (action is always coincident with contact), the software program automatically sets the probability of action to 100% for these events.

Deriving Vulnerability. Vulnerability is derived through a comparison of object control strength versus the force applied against the object. In the FAIR model, the manner in which threat force (capability) is measured depends upon the nature of the threat force. For example, if the threat is a tornado, the force being measured is wind speed. In this instance, the strength of the object under analysis would be measured as resistance to wind speed. If, then, a tornado's maximum wind speed is 350 mph, and the structural characteristics of a building was that it could withstand 100 mph winds, then vulnerability is said to exist.

Measuring the vulnerability of an object relative to a human threat community is challenging because no standard scales of force have previously been developed. The FAIR model defines a scale that ranges from approximately 0 to approximately 1. The reason these endpoint values are approximate is because there are essentially no human threat agents who are completely unable to apply force, nor are there human threat agents who are able to apply infinite force. The increments between 0 and 1 are defined in terms that allow threat community capability to be recognized and represented. Here again, a distribution is used to represent threat capability in order to more accurately reflect the fact that the force characteristics of any population are going to be distributed unevenly across the population.

Measuring Threat Capability. In treating non-human threats, FAIR leverages existing scales such as temperature, pressure, etc., to measure threat capability (force). For human threats, no such scale has previously existed, so FAIR establishes one. Factors that drive threat capability include a combination of the knowledge, experience, and resources of the threat agent. FAIR provides a set of scales that a human analyst can use to define the capability distribution of threat communities. An example is shown below:
0.02=Very Low (e.g., absolute novices)
0.16=Low (e.g., must use simple tools and follow a “cook book”)
0.50=Average (e.g., able to use common tools and techniques)
0.84=Above Average (e.g., able to use advanced tools and techniques)
0.98=True Experts (e.g., able to create new exploits and techniques)

Note that these increments are derived from standard deviations of a bell curve with a mean of 0.50. as shown below.

[image]

Measuring Object Control Strength. The strength of anything is always measured relative to a standard scale of applied force. For example, pounds per square inch (psi.) of force is used to measure the tensile strength of rope. Likewise, within FAIR, object control strength is determined based upon an appropriate threat type and scale (e.g., weight). For human threats, FAIR leverages the threat capability scale (described above) as a baseline for measurement. In other words, if an analyst were to rate the strength of a particular control, they could describe that control strength using the 0 through 1 scale described above. This measure can be made as a distinct value if rating a single object, or as a distribution if rating the strength of a population.

Note that threat capability and control strength vary over time based upon a number of factors. To reflect this, the analyst is able to enter a value that represents the level of confidence for maintaining control strength over time. This rating will typically dampen the control strength distributions to reflect lower overall expected strength.

The ability of objects to resist threat force comes from preventive control elements, as well as detective and responsive control elements. The three preventive control elements available to objects are authentication, authorization, and structural integrity. Each of the preventive control elements is rated by the analyst using the threat force scale described above. The detection and reactive control elements are rated on a 0 to 1 scale that describes their expected degree of effectiveness.

Importantly, the three preventive control elements are not additive. In other words, the authentication and authorization controls are only effective against threat events that attempt compromise through those points of access that employ authentication and authorization. In these cases, structural integrity controls play no role. In those cases where threat agents attempt compromise through a break in structural integrity, authentication and authorization controls play no role.

Note, too, that the effectiveness of authorization is predicated upon authentication. If authentication is violated, authorization is limited in its ability to prevent activity. At best, it limits the nature of the actions that can be imposed upon the object by the threat agent. Using a data file example, authorization can only control whether the file can be read, written to, deleted, etc.

The program derives vulnerability by doing a MC or other such conventional analysis of the threat community capability distribution versus the control strength characteristics of the object. With each MC cycle, the selected threat capability is compared against the control strength, and the output is used to develop a vulnerability distribution. Which control element is tested (authentication/authorization versus structural integrity) depends upon the threat community characteristics. For example, for a tornado, authentication and authorization play no role and would not be included in the determination of vulnerability.

Deriving Impact. Impact reflects the probable loss magnitude of an event in financial terms. Because determining exact loss projections is impractical, the preferred embodiment of FAIR instead projects loss probability within ranges. This significantly streamlines the time required to perform an analysis, accounts for the imprecision in predicting future events, and yet still provides a useful approximation of loss magnitude probability. Note that the software program provides the means for loss ranges to be adjusted by the analyst to effectively represent the environment under analysis. For example, the set of loss ranges described below may be appropriate for a large corporate environment, but may be too large in scale for a small business, in which case a smaller scale can be used, as will be understood by the person of ordinary skill.
1. Less than $10K
2. Less than $100K
3. Less than $1M
4. Less than $10M
5. Greater than $10M

These values are derived by the characteristics of the objects at risk, characteristics of the environment, as well as the characteristics of the threat community posing the potential for harm. Key factors within each impact domain are used by FAIR to determine the probable loss magnitude within a scenario.

Measuring Operational Impact. As defined within this model, operational losses are those losses in productivity associated with lost integrity or availability of data or systems, as well as the costs of recovering degraded data or systems capabilities.

The first step is to identify, through interviews with the business stakeholder(s) how much loss is expected per day of outage. The second step is to identify, through discussions with appropriate staff, the expected recovery time and the expected costs associated with recovery. The loss per day (LPD) and expected recovery time (ERT) are multiplied, and then the recovery costs added. This provides a baseline for operational impact that then is modified (up or down) based upon additional operational loss domain factors (FIG. 8).

Measuring Regulatory Impact. Regulatory losses are primarily associated with liability resulting from lost confidentiality of sensitive information. In other words, the more sensitive the data, the greater potential for harm to the subject(s) of the data and, therefore, the greater potential for significant regulatory fines and costs. For example, in order to experience a loss greater than $1M due to regulatory sanctions (regulatory impact domain), specific factors or conditions must exist (e.g., information assets of a specific level of sensitivity, regulations must exist that impose large financial penalties for such events, and an absence of due diligence in the protection of the information [a value versus exposure calculation], etc.). These factors are rated by the analyst and used by the FAIR software program to determine a probable loss magnitude. The FAIR probability determination is based upon a combination of lookup table values and mathematical formulas.

An example lookup table for regulatory impact is shown below. In this example, an information asset is rated on a 1 to 5 scale for both sensitivity and volume (two of the factors that drive regulatory loss). Within the table, at the intersection of the ratings, is a value that corresponds to the loss range scale shown above.

The value arrived at through the lookup table may be modified (subtracted from, added to, multiplied by, etc.) by other factors related to the loss domain (reference FIG. 8).

[image]

Measuring Legal Impact. The logic behind FAIR's treatment of legal impact is similar to that used in regulatory impact, and in fact uses the same primary input variables of information sensitivity and volume. A lookup table is defined for this loss domain based upon subject matter expert input. Additional legal impact factors (reference FIG. 8) are used to modify loss projections.

Measuring Competitive Advantage Impact. The logic behind FAIR's treatment of competitive advantage impact is similar to that used in regulatory and legal impact, and in fact uses the same primary input variables of information sensitivity and volume. A different lookup table is defined for this loss domain (not shown), based upon subject matter expert input. Additional competitive advantage impact factors (reference FIG. 8) are used to modify loss projections.

Measuring Reputational Impact. Probable reputational impact is dependent upon factors such as the brand (reputational) sensitivity of the organization, whether it's publicly held, the degree of due diligence performed by the organization, as well as the amount, nature, and duration of publicity, etc. The analysis establishes these values through dialog with the appropriate organizational stakeholders prior to performing the analysis.

Using the FAIR methodology to measure the risk within an environment first requires that the analyst create a simulated representation of the environment using the software program interface. A simple example follows. If a user wanted to analyze the risk associated with a single server containing a data file, and the risk was based upon a threat community composed of disgruntled employees, the analyst would:
Select a server object icon from the object type menu, and place it onto the workspace (FIG. 13)
Right click on the server icon to open the server configuration menu
Configure the following server settings:

[image]

Note that these settings can be saved as default values or applied to a set of servers if more than one server needed to be configured.

Next, the analyst would select a data object and drag it onto the server

[image]

object, and then right click on the server icon to open the data configuration menu and then Configure the following data settings.

Note that unless data is encrypted, it doesn't inherently have preventative controls. Furthermore, data is reliant upon its meta-object for detective and responsive controls.

Subsequently, the analyst can add objects to the workspace and perform the same steps outlined above. Note also that as objects are added to the workspace (or at any time thereafter), the user can enter values into configuration variables for each object, which describes the objects' characteristics (e.g., various strength values, impact values, etc.).
Select the Disgruntled Employee threat community icon and drag it onto the workspace.
Configure the Disgruntled Employee threat community characteristics. Note that most threat community settings are preconfigured, but can be adjusted through an advanced configuration option. Most of the settings shown below would, in fact, be preconfigured. The settings below are provided as references for the computational description that follows. [image]
Configure values for variables that describe global or exogenous factors such as regulatory, legal, competitive, or reputational considerations.

[image]

Note that the settings above show only those that apply to this scenario (although the HIPAA regulation is included to illustrate that there are many regulations in existence, not all of which would be in play on any given scenario). A person of ordinary skill will recognize that in other scenarios, other settings mentioned herein and apparent from those mentioned herein, will be used.

Once the simulated environment has been built within the workspace, the user initiates the risk analysis component of the software (i.e., selects the Run option).

At this point, the program performs the following operations with the data entered for the environment and the configurations defined by the user (specific computational processes described earlier). Note that the first stage of the computation is an analysis of risk associated with the server and the disgruntled employee threat community. The second stage is an analysis of risk associated with the data and the disgruntled employee threat community.

In the first Stage, which is the Server vs. Disgruntled Employee Threat Community, the program computes the vulnerability of the server using the following variables (FIG. 7):
Computes the vulnerability of the server using the following variables (FIG. 7):
   Disgruntled employee capability
   Server authentication control strength
   Server authorization control strength
Computes the probability of random contact between the disgruntled employee threat community and the server using the following variables (FIG. 5):
   Disgruntled employee volume
   Disgruntled employee activity level
   Disgruntled employee selectiveness
   The relative surface area of the server based upon the number of objects in the environment (objects at the same level of abstraction as the server)
Computes the probability of targeted contact with the server using the following variables (FIG. 5):
   Disgruntled employee volume
   Disgruntled employee activity level
   Disgruntled employee selectiveness
   The relative surface area of the server based upon the number of objects in the environment (objects at the same level of abstraction as the server)
   Characteristics matching between the disgruntled employee threat community and the server object (value, type, etc.)
Computes the probability of combined random and targeted contact based upon the results of the prior two steps.
Computes the probability of action using the following variables (FIG. 6):
   Characteristics matching
      Value
      Vulnerability
      Detective and responsive controls relative to threat community risk tolerance
Computes the threat event frequency based upon the results from of contact and action analysis (FIG. 4).
Computes the exposure based upon the results from threat event frequency and vulnerability (FIG. 2).
Computes operational impact using the following variables:
   Server expected loss per day
   Server expected recovery time
   Server expected recovery costs
   Disgruntled employee secondary intent
Computes legal impact using the following variables:
   Server combined value (criticality, and market)
   Computed exposure (derives due diligence measure)
   Environmental variable—Publicly Held
Computes regulatory impact using the following variables:
   Server combined value (criticality, market)
   Computed exposure (derives due diligence measure)
   Environmental variables—Regulations
Competitive advantage impact is not computed for the server, as the key competitive advantage factor—sensitivity—is not a characteristic of the server. Of course, it will be apparent that this impact is relevant in other situations.
Computes reputational impact using the following variables:
   Server combined value (criticality, and market)
   Computed exposure (derives due diligence measure)
   Environmental variable—Publicly Held

In the second Stage, the Data vs. Disgruntled Threat Community, the program
Computes the vulnerability of the data using the following variables (FIG. 7):
   Disgruntled employee capability
   Data authentication control strength
   Data authorization control strength
Computes the probability of random contact between the disgruntled employee threat community and the data using the following variables (FIG. 5):
   Server exposure—note that disgruntled employees are only able to come into contact with the data if they have managed to compromise the data's meta-object (the server). This probability of server compromise is used in place of disgruntled employee volume for this computation.
   Disgruntled employee activity level
   Disgruntled employee selectiveness
   The relative surface area of the data based upon the number of objects in the environment (objects at the same level of abstraction as the data)
Computes the probability of targeted contact with the data using the following variables (FIG. 5):
   Server exposure—note that disgruntled employees are only able to come into contact with the data if they have managed to compromise the data's meta-object (the server). This probability of server compromise is used in place of disgruntled employee volume for this computation.
   Disgruntled employee activity level
   Disgruntled employee selectiveness
   The relative surface area of the data based upon the number of objects in the environment (objects at the same level of abstraction as the data)
   Characteristics matching between the disgruntled employee threat community and the data object (value, type, etc.)
Computes the probability of combined random and targeted contact based upon the results of the prior two steps.
Computes the probability of action using the following variables (FIG. 6):
   Characteristics matching
      Value
      Vulnerability
      Detective and responsive controls relative to threat community risk tolerance
Computes the threat event frequency based upon the results of contact and action analysis (FIG. 4).
Computes the exposure based upon the results from threat event frequency and vulnerability (FIG. 2).
Computes operational impact using the following variables:
   Data expected loss per day
   Data expected recovery time
   Data expected recovery costs
   Disgruntled employee secondary intent
Computes legal impact using the following variables:
   Data combined value (sensitivity, criticality, and market)
   Data volume
   Computed exposure (derives due diligence measure)
   Disgruntled employee primary intent
   Environmental variable—Publicly Held
Computes regulatory impact using the following variables:
   Data combined value (sensitivity)
   Data volume
   Computed exposure (derives due diligence measure)
   Disgruntled employee primary intent
   Environmental variables—Regulations
Computes competitive advantage impact using the following variables:
   Data value (sensitivity)
   Data volume
   Computed exposure (derives due diligence measure)
   Environmental variable—Publicly Held
Computes reputational impact using the following variables:
   Data combined value (sensitivity, criticality, and market)
   Data volume
   Computed exposure (derives due diligence measure)
   Environmental variable—Publicly Held

After the risk analysis is complete, the screen is updated with the results. Results are displayed both graphically, and through a selection of documented reports. The user also can click on any object on the screen to drill down into specific information regarding that object.

A selection of report formats can be chosen from to identify control deficiencies, vulnerability, exposure, impact, and risk. The program also will identify:
Highest points of risk (those objects whose risk level is above a user defined threshold)
Average risk throughout the environment
Lowest risk (those objects whose risk level falls below a user defined threshold)
Key points of leverage within the environment where additional control strengthening will affect significant risk reduction throughout the environment
Points of fragility within the environment where a single point of control failure would result in a material change in risk (absence of defense-in-depth)
Points of instability where low exposure conditions are contingent upon low probability of threat events (versus low exposure due to effective controls)
Most significant threat community (based upon risk)

The size and complexity of an analysis is theoretically unlimited, although memory and other common computer processing constraints may impose practical limitations.

The invention is an accurate method for performing analysis of information risk. Threats exploit vulnerabilities to affect assets, resulting in impact that typically takes one or more of several forms: legal, regulatory, operational, competitive advantage and reputational. The information security exists to manage this.

The instant invention takes high level factors and defines the sub-factors that make them up, and performs a statistical analysis relating to the relationships between the factors. Theoretically, one can factor down to an absolute level, to a binary (yes or no) condition. That degree of factoring, other than as a scientific exercise, isn't going to get a user much closer to understanding or measuring risk on a practical level.

By entering values for assets, threats, vulnerabilities, and control effectiveness, one can calculate a risk point on a chart or in a data set. If one changes the control values, one sees a change in the risk condition—lowering the probability, lowering the impact. This can be used to run what-if scenarios and project a return on investment.

This process also makes it easy to identify which factors are the important ones—i.e., points of leverage. Using this process then, one can determine what will give the greatest return on investment in managing information risk.

The FAIR process gives you a means of measuring, understanding, and articulating information risk. The process gives a concise means of articulating and communicating risk. If one has no effective process in place to monitor changes being made to the system, or ensure that new software patches are applied in a timely manner to protect against newly reported vulnerabilities, then a system intended to be secure won't stay secure. These are control issues that other risk assessment methods don't take into account or, if they do, they don't do so from a perspective of how these weaknesses play into the larger picture.

One of the elusive objectives of information risk analysis has been quantifying impact in dollars. To-date, it's always been qualitative—e.g., high impact versus low impact, for example. FAIR uses a logarithmic scale to provide a range of probable loss. In other words, losses can be below 10k, between 10k and 100k, between 100k and 1 mil, etc. The ranges can be adjusted to match the size of the organization under assessment. It isn't a precise measurement, but then precision isn't called for. The invention can project an expected amount of loss by understanding the factors that drive certain degrees of loss. For example, in order to experience a loss in the legal domain of between $1 million and $10 million dollars, the following factors need to exist—e.g., a certain volume of a certain sensitivity of information, a lack of due diligence in protecting the information, etc.

The following can be other combinations of steps in a method.

A method of measuring information security risk based upon:

A taxonomy of key risk factors.

An object modeling construct used to emulate the environment under analysis.

A set of measurement scales for the risk factors.

A statistical method that derives risk values based upon mathematical processes of modeling the risk factor relationships.

A software program interface.

In support of claim 1, a method of measuring risk based upon the intersection of loss event probability (exposure) and the probable loss associated with the event (impact).

In support of claim 2, a method of measuring loss event probability (exposure) as the probable frequency of coincident occurrence of threat event and vulnerability to that threat event.

In support of claim 3, a method of measuring threat event frequency as resulting from the probable frequency of contact with a threat agent, and the probability of the threat agent acting against the asset or assets under analysis.

In support of claim 4, a method of measuring the contact between one or more threat agents and the object(s) under analysis based upon:

The probability of random contact between threat agent(s) and object(s).

The probability of targeted (intentional) contact between threat agent(s) and object(s).

In support of claim 5, a method of measuring the probability of random contact between threat agent(s) and object(s) based upon:

The exposed area of the object(s).

The volume and level of threat agent activity.

The proximity of object(s) and threat agent(s).

In support of claim 5, a method of measuring the probability of targeted (intentional) contact between threat agent(s) and object(s) based upon:

The exposed area of the object(s).

The volume and level of threat agent activity.

The proximity of object(s) and threat agent(s).

The value of the object(s) relative to threat agent characteristics such as intent and motive.

In support of claim 4, a method of measuring the probability of a threat agent or agents acting against object(s) based upon:

The value of the object(s) relative to threat agent characteristics such as intent and motive.

The vulnerability of the object relative threat agent capability.

The degree of risk to the threat agent based upon the characteristics of the object(s) and the environment under analysis.

In support of claim 3, a method of measuring vulnerability as the statistical probability of compromise occurring based upon Monte Carlo analysis of threat capability versus control strength.

In support of claim 9, a method of measuring threat agent capability using a distribution over a scale.

In support of claim 9, a method of measuring intended control strength using a standard threat capability distribution as a baseline.

In support of claim 9, a method of measuring probable effective control strength over time based upon the intended/implemented control strength and the probable likelihood that control strength will be maintained over time (confidence).

In support of claim 2, a method of measuring loss magnitude probability based upon a combination of the following loss domains:

Operational losses.

Legal losses.

Regulatory losses.

Competitive advantage losses.

Reputational losses.

In support of claim 13, a method of measuring probable loss domain magnitude based upon two categories of factors:

Primary factors.

Secondary factors.

In support of claim 14, a method of measuring probable loss domain magnitude based upon two categories of factors:

Primary factors.

Secondary factors.

In support of claim 15, a method of measuring the probable loss associated with the following primary factors:

Object value.

Object volume.

Threat capability.

Threat intent.

Detective and responsive controls.

In support of claim 15, a method of measuring the probable loss associated with secondary factors that are specific to each of the loss domains.

In support of claim 17, a method of measuring the probable loss associated with the operational loss domain factors:

Event timing.

Replacement/recovery costs.

Degree of operational degradation.

Duration of operational degradation.

Lost productivity or capabilities.

In support of claim 17, a method of measuring the probable loss associated with the legal loss domain factors:

Degree of due diligence in advance of the event.

Degree and nature of publicity.

Remediation type (e.g., settlement, fine, imprisonment, etc.).

Specific law violated or tort.

Litigation type (e.g., civil, criminal).

Number of litigants.

Available legal expertise.

Duration of legal proceedings.

Responsiveness on the part of the subject.

In support of claim 17, a method of measuring the probable loss associated with the regulatory loss domain factors:

Potential harm.

Degree of due diligence in advance of the event.

Specific regulation violated.

Responsiveness on the part of the subject.

In support of claim 17, a method of measuring the probable loss associated with the competitive advantage loss domain factors:

Nature of a competitor's use of the event for subject's competitive disadvantage.

In support of claim 17, a method of measuring the probable loss associated with the reputational loss domain factors:

Severity of the event in operational, legal, regulatory, and competitive advantage.

The nature and degree of publicity.

Degree of due diligence in advance of the event.

Responsiveness on the part of the subject.

Victim(s) sensitivity.

In support of claim 1, a method of emulating the environment under analysis using an object construct. Objects are the physical, virtual, or logical building blocks of the environment under analysis. The object construct provides a basis for defining specific key object characteristics through standard descriptive tags.

In support of claim 23, a method of allowing for the development of complex object structures through imbedding objects within other objects.

In support of claim 24, a method of describing meta-objects as those objects that contain other (imbedded) objects.

In support of claim 25, a method of representing meta-object value as a combination of the intrinsic value of the meta-object and the inherited value from all contained objects.

In support of claim 25, a method of representing contained object exposure as a combination of the degree of exposure inherent in the contained object environment plus any inherited exposure imposed by the meta-object.

In support of claim 23, a method of describing object preventive controls as consisting of authentication, authorization, and structural integrity components.

In support of claim 28, a method of describing structural integrity control as those characteristics of an object that inhibits the direct effects of actions against the object, as well as the ability to prevent circumvention of authentication and authorization controls.

In support of claim 23, a method of describing objects using a discreet set of characteristics. These characteristics allow differentiation between different types of objects, and define the manner in which objects interact with other objects and threat agents within an environment.

In support of claim 1, a method of describing threat agent communities (specific categories of threat agents) using a set of discreet characteristics. These characteristics allow differentiation between threat community capabilities and tendencies, and define the manner in which threat communities interact with objects within an environment.

In support of claim 1, a method of performing risk analysis using a computer software program that enables the user to simulate a risk environment by:

Emulating the environment under analysis by dragging and dropping objects into a worksheet.

Entering values into variable fields within objects that correlate to the object characteristics.

Defining the threat communities within the environment.

In support of claim 32, a method of measuring risk within a simulated computer software program that:

Applies mathematical formulas to emulate the relationships and interactions between the objects and threat communities defined by the user.

Represents and reports the risk within the simulated environment through graphs and charts that identify key points of vulnerability, exposure, impact and risk.

While certain preferred embodiments of the present invention have been disclosed in detail, it is to be understood that various modifications may be adopted without departing from the spirit of the invention or scope of the following claims.

1. A method of measuring and representing security risk, the method comprising:
(a) selecting at least one object within an environment;
(b) quantifying the strength of controls of at least one object within that environment by:
(i) quantifying authentication controls;
(ii) quantifying authorization controls; and
(iii) quantifying structural integrity;
(c) setting global variables for the environment [e.g., whether the environment is subject to regulatory laws];
(d) selecting at least one threat community [e.g., professional hacker]; and
(e) calculating information risk by:
(i) performing a statistical analysis, using the strengths of controls of said at least one object, the characteristics of at least one threat community, and the global variables of the environment, to compute a value representing information risk.
